(19) United States
(12) Patent Application Publication
(10) Pub. No.: US 2022/0084144 A1
(43) Pub. Date: Mar. 17, 2022

(54) SYSTEM AND METHOD FOR CUSTOMIZABLE AND PROGRAMMABLE TOOLS

(71) Applicant: FLOWMATIKS TECHNOLOGIES, INC., Warrenville, IL (US)

(72) Inventor: Samuel J. Kwak, Warrenville, IL (US)

(21) Appl. No.: 17/474,930

(22) Filed: Sep. 14, 2021

Related U.S. Application Data
(60) Provisional application No. 63/078,229, filed on Sep. 14, 2020.

(51) Int. Cl. G06Q 50/16; G06Q 10/10; G06Q 10/06

(52) U.S. Cl. CPC G06Q 50/163; G06Q 10/063116; G06Q 10/1097

(57) ABSTRACT

Disclosed are example embodiments of for systems and methods for a computer system coupled to a network for scheduling and optimizing property management communications, activities, and tasks, the computer system configured to: provide a plurality of graphical user interfaces for creating, editing, and deleting optimized digital data for one or more property management tasks, upon receiving a request from a user device coupled to the network, create a digital tag, wherein the digital tag is defined to start or stop a property management task, start the property management task when a first condition defined by the digital tag is met, and stop the property management task when a second condition defined by the digital tag is met.

### CLAIM OF PRIORITY UNDER 35 U.S.C. & 120

The present Application for Patent claims priority to U.S. Provisional Patent Application No. 63/078,229, filed Sep. 14, 2020, and assigned to the assignee hereof and hereby expressly incorporated by reference herein.

### FIELD

The present disclosure relates generally to the field of software tools, and more specifically to systems and methods for creating customizable and programmable tools. The software tools may allow users to schedule communications, software activities, and tasks for current and/future executions.

### BACKGROUND

Property managers and landlords are faced with a dilemma of either hiring more people to handle their operational tasks or simply neglect the quality of how such tasks are processed. These tasks are often time consuming, inefficient and error prone. When tasks are not adequately performed and/or performed on-time, property managers and landlords also face liability in discrimination, in negligence and malpractice. Currently in the market, property managers and landlords would need to subscribe to multiple software tools and applications to handle their operational tasks. However, utilizing multiple software tools can cause breakage, sophisticated errors, and are often susceptible to user errors as well. Many of these tools and applications are not even industry specific and property managers/landlords are left to use tools that may be limited in features for their specific use case.

Currently in the property management and landlord industry, problems include waste and inefficient use of resources to complete tasks. As an example, a property management process is often repetitive, mundane, and time consuming. Just as with any business, the property management processes are prone to human errors and mistakes which can cause unnecessary cost of time and financial resources. For example, a property manager receives a request for a repair on a regular basis. Sometimes, these requests may be overwhelming and nearly impossible to manage the requests with equal attention and effort. This causes the repair request to be forgotten or underserved. This also leads to the underlying problem-to-be-repaired to become bigger; leading to frustrated and unhappy tenants and owners of the real property. This is one example of the property management process that often suffer a detrimental cost. The example can also be applied to situations related to renewal of lease agreements, new tenant applications, delinquent tenants who fail to pay rent on time, or other property management situations.

Therefore, needs exist for systems, devices and methods to allow users to schedule communications, software activities, and tasks for current and/future executions that also serve the specific use for property managers. The systems, devices and methods also include integrated key functionalities from the several software services, including innovative components.

### SUMMARY

Provided herein are example embodiments of systems, devices and methods for creating customizable and programmable tools. The software tools may allow users to schedule communications, software activities, and tasks for current and/future executions.

Generally, embodiments of the present disclosure may provide a consistent process of tasks and communication which may alleviate the risk of a property management company from the liability of discrimination, for example by streamlining all communication and operation of the company to a pre-programmed sequence. The present disclosure may also alleviate the liability of negligence and malpractice since embodiments of the present disclosure may provide automated sequence of tasks and communication such that wastes and errors may be eliminated which can cost owners of real estate property time and money. Previously, property managers and landlords were faced with a dilemma of either hiring more people to handle the operational tasks or simply neglect the quality of how such tasks are processed. With systems, devices and methods of the present disclosure, property managers and landlords no longer rely on an increase of human interaction for each of operational tasks which increases profit for the business.

In some embodiments, the present disclosure may apply to real estate (real property) management, asset management, short-term housing rental, vacation home rental, and management of other dwelling and/or leasable space.

However, the systems, devices and methods of the present disclosure may also apply to other fields to streamline communication and operation to a pre-programmed sequence.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional features and advantages of the invention will be set forth in the descriptions that follow, and in part will be apparent from the description, or may be learned by practice of the invention. The objectives and other advantages of the invention will be realized and attained by the structure particularly pointed out in the written description, claims and the appended drawings.

### BRIEF DESCRIPTION OF THE DRAWINGS

FIG. 1 illustrates an exemplary system of the present disclosure.

FIG. 2 illustrates an exemplary server (or server system) of the present disclosure.

FIG. 3 illustrates an exemplary the user device is illustrated.

FIG. 4 illustrates an exemplary process is illustrated to assist property management firms, landlords, and/or any individuals that are responsible for management of real property.

FIG. 5 illustrates an exemplary sequence execution process, according to some embodiments, is illustrated.

FIG. 6 illustrates an exemplary process where a customer fails to pay for a service, for example, a tenant fails to pay rent.

FIGS. 7A and 7B illustrate exemplary user interfaces (GUIs) showing exemplary options for creating, organizing, editing, and deleting a tag.

FIGS. 8A and 8B illustrate exemplary user interfaces (GUIs) showing exemplary options for creating and editing a sequence.

FIG. 9 illustrates an exemplary user interface (GUI) showing exemplary options for stopping a sequence.

FIGS. 10A to 10H illustrates exemplary data structures used in support of systems, procedures and methods of the present disclosures.

FIG. 11 illustrates an exemplary block diagram illustrating an example of a processing system in which at least some operations described herein can be implemented.

FIG. 12 illustrates an exemplary user interfaces (GUIs) showing exemplary options for creating and editing a sequence.

FIG. 13 illustrates an exemplary user interfaces (GUIs) showing exemplary options for creating and editing a sequence.

FIGS. 14A to 14M illustrate other exemplary data structures used in support of systems, procedures and methods of the present disclosures.

FIG. 15 is a flowchart of an example method.

### DETAILED DESCRIPTION

The following disclosure describes various embodiments of the present invention and method of use in at least one of its preferred, best mode embodiment, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Generally, embodiments of the present disclosure include systems and methods for creating customizable and programmable tools. The software tools may allow users to schedule communications, software activities, and tasks for current and/or future.

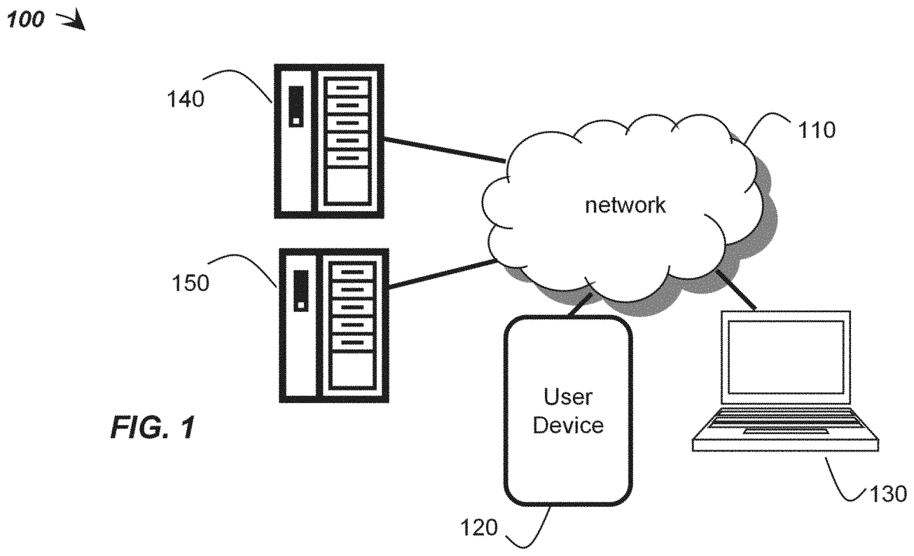

Referring to the figures, FIG. 1 illustrates an exemplary system 100 of the present disclosure. In some embodiments, the exemplary system 100 may include a server (or server system) 140 which may be distributed on one or more physical servers, each including processor(s), memory, an operating system, and input/output interfaces, and a network interface all known in the art, and a plurality of end user computing devices 120/130 coupled to a public network 110, such as the Internet and/or a cellular-based wireless network. The user computing devices 120/130 may include desktop, portable and wearable devices each including processor(s), memory, an operating system, and input/output interfaces, and a network interface all known in the art.

In some embodiments, the exemplary system 100 may include one or more third-party server or server system 150. The third-party servers may provide services such as Simple Mail Transfer Protocol (SMTP) email relay service, text message delivery service, Voice over Internet Protocol (VOIP) call vendors, etc., that are integrated within the exemplary system 100. The third-party services can be interchangeable but fundamentally, each service may be responsible in delivery of messages, voice transmission, text content, and media that have been originated through the exemplary system 100. The exemplary system 100 may process each of the communication and tasks on a time-based fashion and provide the content of each communication (e.g., user generated email messages).

Note that the location of logic and storage, while separated in the embodiment shown in FIG. 1 may be combined, separated, or even sub-divided in different embodiments. In some embodiments, various elements of the system of the present disclosure may be implemented in software executable by a processor, in hardware (e.g., integrated chip) or a combination thereof.

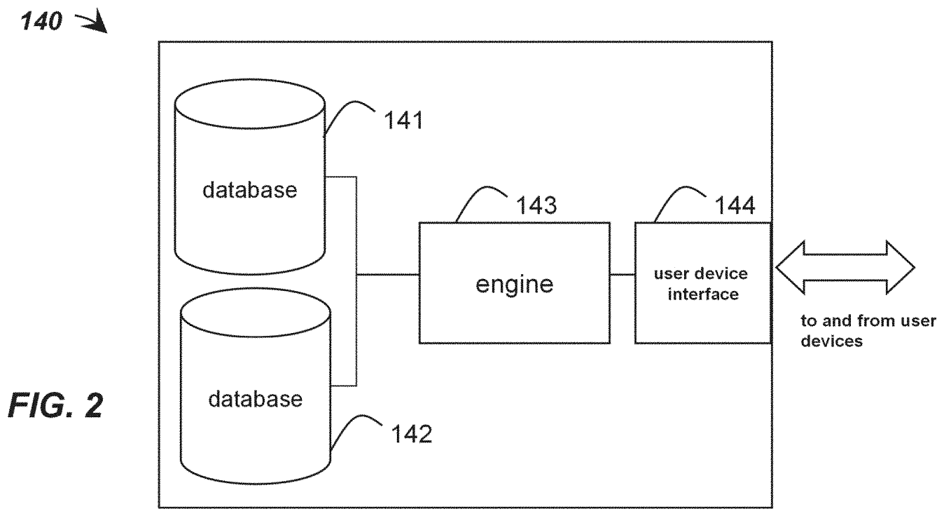

FIG. 2 illustrates an exemplary server (or server system) 140 of the present disclosure. Generally, a server (or server system) 140 may include a computer-based application or engine 143 designed to enable users to create a customizable and programmable tool that allows the users to schedule communications, software activities, and tasks for current and/or future executions. Such series of communication, software activities, and tasks may constitute a “sequence”. In an exemplary property and user management embodiment, such communications, activities, and tasks may include, for example:

1. Sending an email broadcast to one specific individual and/or a group of designated tenants, vendors, and/or owners of real estate.

2. Sending an Short Message Service (SMS) text broadcast message to one or more recipients that are deemed to be the users' tenants, vendors, and/or owners of real estate.

3. Create a task for a user and the user's party members to execute immediately or at any future period with specific instructions, due dates, and/or association to specific tenants, properties, and/or owners of real estate.

4. Create either a payable and/or receivable invoice item within the system/software for the user to pay/receive immediately or at any future date.

5. Create and/or store documents with templates created by the user for specific use case on tenants, properties, vendors, and/or owners of real estate.

6. Create and update notifications to lead users, system/software users, vendors, tenants, and owners of real estate property through the means of browser notifications and/or mobile “push notifications”.

7. Create delays in between communications, actions, and/or tasks that are pre-programmable by the user.

8. Add remarks, notes, annotations to pre-existing records and data associated with tenants, vendors, properties, and owners of real estate.

9. Add or remove snippets and labels of metadata called “tags” to owners, vendors, properties, and tenants, and other application users which may cause certain conditions of each objects to change. For example, a scenario where a tag is useful is that users can filter records of properties, tenants, owners, and/or vendors by tags. Users can apply a filter that would bring up records that have a specific tag. Another use case would be to send a mass broadcast email to tenants with a specific tag applied to their record—allowing for distinction and targeted communication.

Users can also create tags within fixed tag categories such as Property tags, vendor tags, tenant tags, owner tags, or a User tag. The categorization allows for users to create automation sequence funnel that are dedicated to specific objects or data record. For example, an automation sequence funnel dedicated to a property may not work properly if used against a tenant record. To provide clear and concise classification of these user-created sequence funnels, the user can assign tags to specific categories to trigger specific sequence funnels.

10. Application Programming Interface (API) Push or Pull initiation by the software/system.

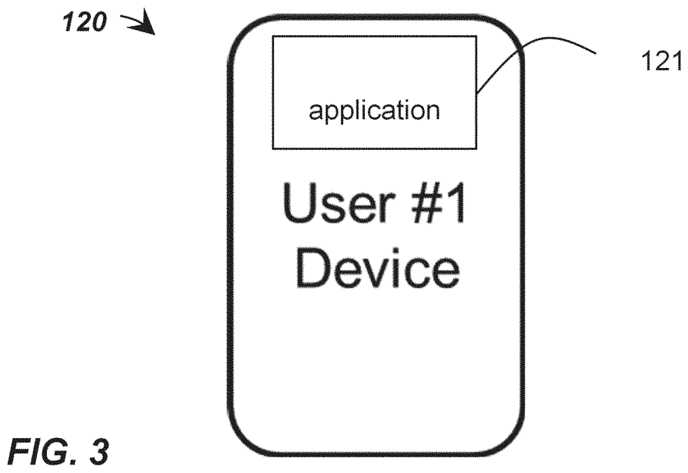

Turning to FIG. 3, an exemplary the user device 1200 (or 1300) is illustrated. Generally, an user device application 121 may be downloaded to the user device 120 by the user of the exemplary system 100. The user device application 121 is designed to operatively communicate with the server (or server system) 140 over the public network 110.

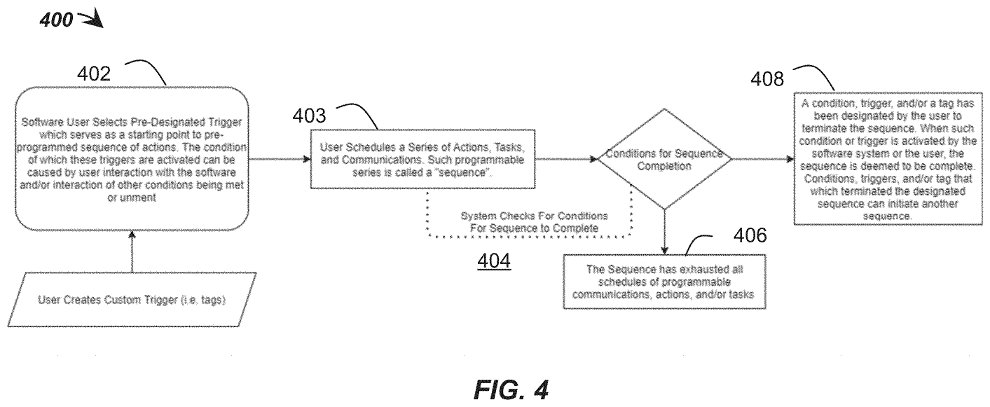

Turning to FIG. 4, an exemplary process 400 is illustrated to assist property management firms, landlords, and/or any individuals that are responsible for management of real property. In some embodiments, the exemplary process 400 (or Property and User Automation Utility) may provide reliable, repeatable, and customizable, pre-scheduling tool that allows users to automate certain repetitive sequence of tasks and property/asset management procedures.

Users can begin at 402 by selecting a specific condition or situations that may frequently arise in a property management business.

Followed by the selection of such condition or situation, at 403 the user may assign a series of executable activities, tasks, or communications in a desirable order. Such series of activities, tasks, or communications are notably called “sequence funnel.” A sequence funnel can terminate by three conditions. (1) The user can designate a condition or a situation that would halt the sequence (at 408) whether the sequence has reached completion or not. (2) The user can manually halt the sequence by direct intervention with the utility, and (3) at 406, the sequence has exhausted all programmed and scheduled activities—thus unable to execute any additional activities, tasks, and/or communications.

In some embodiments, a condition or a situation that halted the sequence may also have served as a trigger to initiate a completely different sequence funnel. Therefore, a sequence that has been halted by a specific condition may initiate another sequence funnel until such sequence funnel is also halted by the three conditions previously described.

In some embodiments, conditions or a situation may be created either by the software system arriving at such condition by normal function, or the conditions or a situation may be artificially created by user interaction or non-interaction with the software system. Such user interaction or non-interaction may happen software-wide, outside of the automation utility tool.

In some embodiments, users may be able to observe the sequence funnels executing in real time and review logs of activities, tasks, and communications that were executed by individual sequence funnels through an activity log provided by the software.

The result may allow the users to schedule future tasks, activities, and communications without manually executing them by mere human interaction thus reducing waste and friction of the user managing a given real property or assets.

Continuing with an example in property management, various exemplary conditions that may initiate and/or halt a sequence funnel will be listed below.

Tag Applied: a tag has been applied to a given object. An Object may be a set of data grouped to identify a real estate property, lead user, tenant user, vendor user, software user, and/or owners of real estate property. A tag can be artificially created by the user. A tag can be given a unique name that is easily identifiable by the user.

Rent Payment Submitted: A tenant has submitted a payment to fully satisfy a balance that has not been paid on a designated period of time.

Delinquent Tenant: A tenant is considered to be late or delinquent in their rent payment. More specifically, a rent payment has not been detected by the system by a designated due date assigned by the user.

Repair Ticket Created: a new repair request ticket has been created either by the software user or a tenant user.

Tenant Moved-Out: a tenant is no longer residing in the associated property or rental unit. The user may be disassociating the tenant data to the property object.

Tenant Moved-In: a tenant has moved into a new property or rental unit. The user has associated a tenant user to a property. The precondition is that the lease has been signed by the tenant user.

New Property Created: a new property object and a record has been created in the software by the user.

New Application Received: a new application file has been received or submitted by a lead user expressing interest in a property. A new form with information has been submitted to the software.

Application Approved: An application submitted by the lead user is now approved.

Application Denied: An application submitted by the lead user is denied.

Lease Signed: a lead user who is now a tenant user has signed and executed an agreement between the software user and the tenant user.

Lease Expiring: a lease agreement is set to expire within a certain period of time. The date of lease expiring is approaching within 30-60 days.

Repair Request In Process: a repair request has been received and is now in process of fulfilling the request.

Repair Request Complete: a repair request has been fulfilled and is now deemed to be complete.

Repair Request Estimate Received: a repair request is now being considered and the cost to fulfill such request has been estimated.

Tenant Eviction In Process: a tenant is marked for eviction/forcible detainer. The software user has filed an eviction request with the local county. The software will no longer allow tenant to submit rental payments.

Lease Expired: a lease has been expired or surpassed the date of the expiration date.

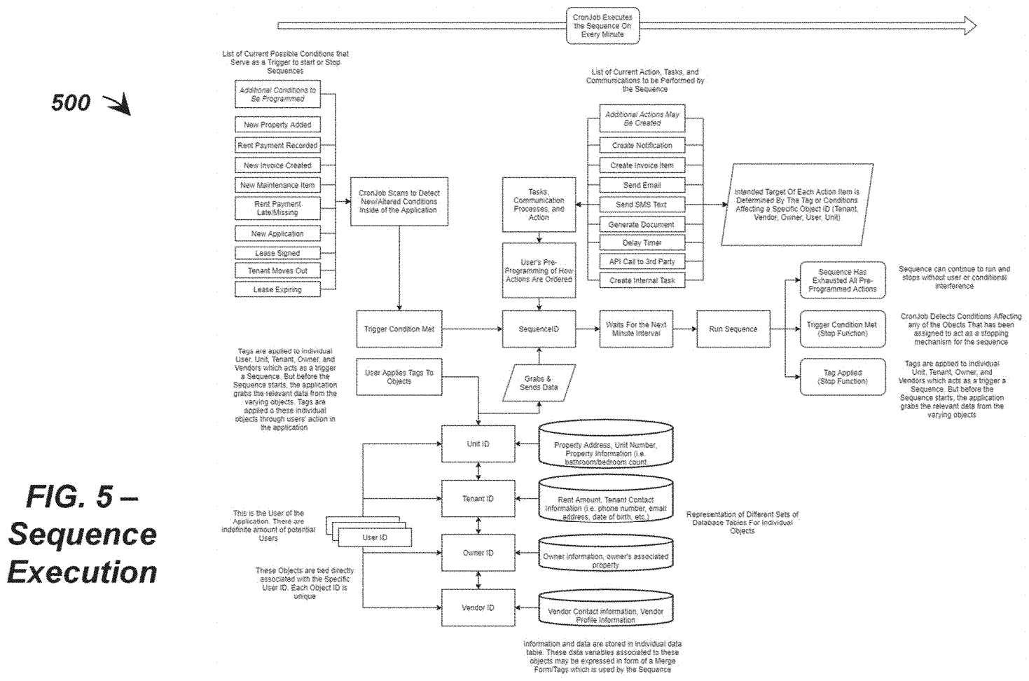

Turning now to FIG. 5, an exemplary sequence execution process 500, according to some embodiments, is illustrated. In some embodiments, on the server side, the exemplary sequence execution process 500 may use Command Run On (CRON) protocol to detect any new tasks and communication that is pre-programmed by the user. This may take place periodically, for example, every minute. The server service may then execute these programmed tasks and communication job (e.g., in batches every minute) to execute the sequence just as the user programmed it. The system may rely on other features and services in the application of the disclosure to recall data and information needed to complete each task and communication. For example, users can input “merge tags” in email templates which the system will automatically replace the merge tag with actual data when the email is sent out as part of the pre-programmed sequence. The user may not see the actual data but may instead see a bracketed label, for example: {{tenant.first.name}}. As the system executes the sequence of tasks and communications, the server may automatically detect such merge tag and replace the merge tag with the data that is correlated to the merge tag. In this example {{tenant.first.name}} is a merge tag for all First Name of tenant information. In some embodiments, {{tenant.first.name}} may not be interchanged with any other information such as Tenant last name or other identifiable information of such tenant. The merge tag will be permanently fixed to each of the corresponding data.

“Merge Tags” can also be created by the user from a custom field. Users may choose to create custom fields or containers for data to which the users can recall such custom data as a merge tag when used for automation and broadcasts.

On the user device side, in some embodiments, the user may access our application through a browser/cloud and no information/data is required to be downloaded into the users' device other than cookies or cached images, videos, or media. The user may, at will, download stored images, documents (Portable Document Format (PDF), docx, or other document formats), videos, audio files, and other text offline to store on the user's storage device. The user may also send and receive emails that have been generated by the system, or a reply from such generated emails that may have been previously sent out through a programmed sequence in the application. Similar procedure may be provided with SMS text message services where users may exchange, receive, and/or send text messages previously generated by the application.

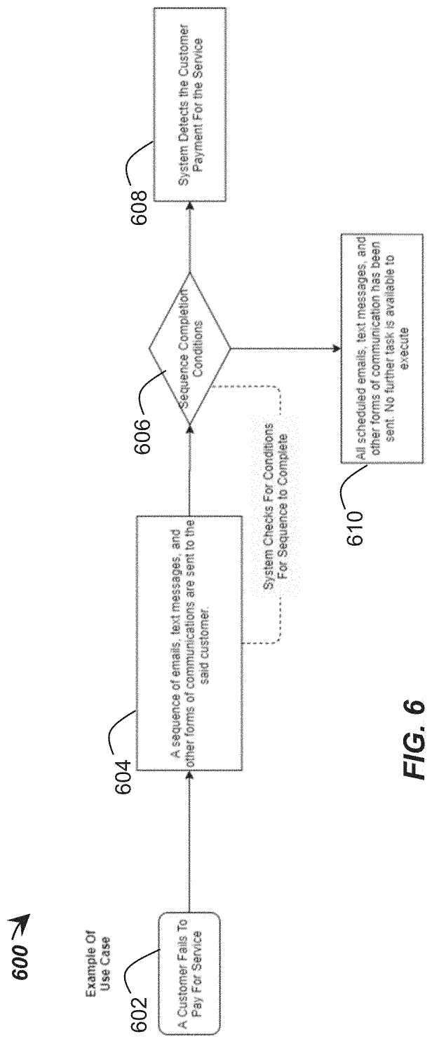

FIG. 6 illustrates an exemplary process 600 where a customer fails to pay for a service, for example, a tenant fails to pay rent. At 602, the trigger is activated based on condition previously set by a user of the system. At 604, based on predefined sequence funnel, the system may generate a series of emails, text messages to the customer. The sequence of activities may terminate at 608 when the system detects payment from the customer, or at 610 when no further activity is defined.

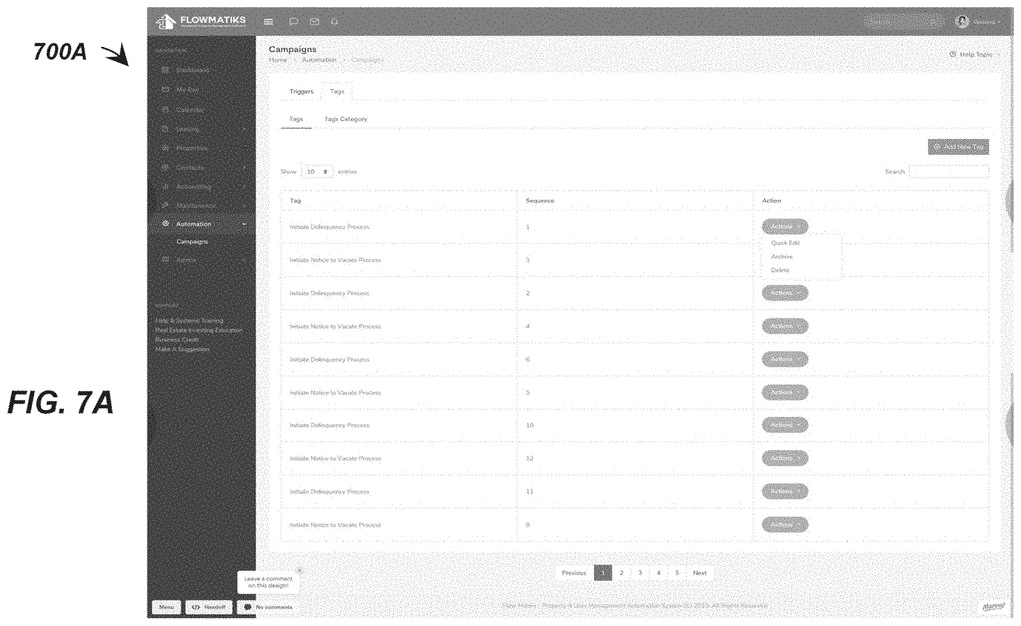

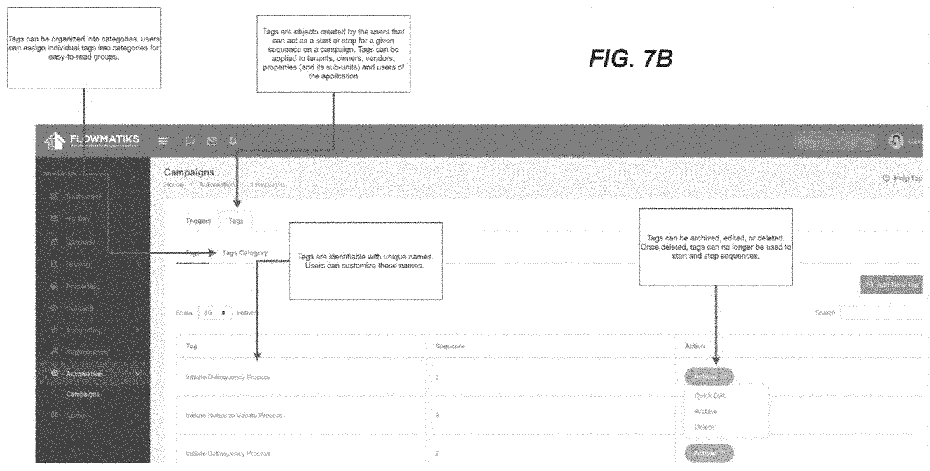

FIGS. 7A and 7B illustrate exemplary user interfaces (GUIs) showing exemplary options for creating, organizing, editing, and deleting a tag. In some embodiments, users may create new tag objects that can be served as a trigger to start and/or stop a sequence funnel. Users may create unlimited tag objects within the system. Users may create, edit, or delete tags at will.

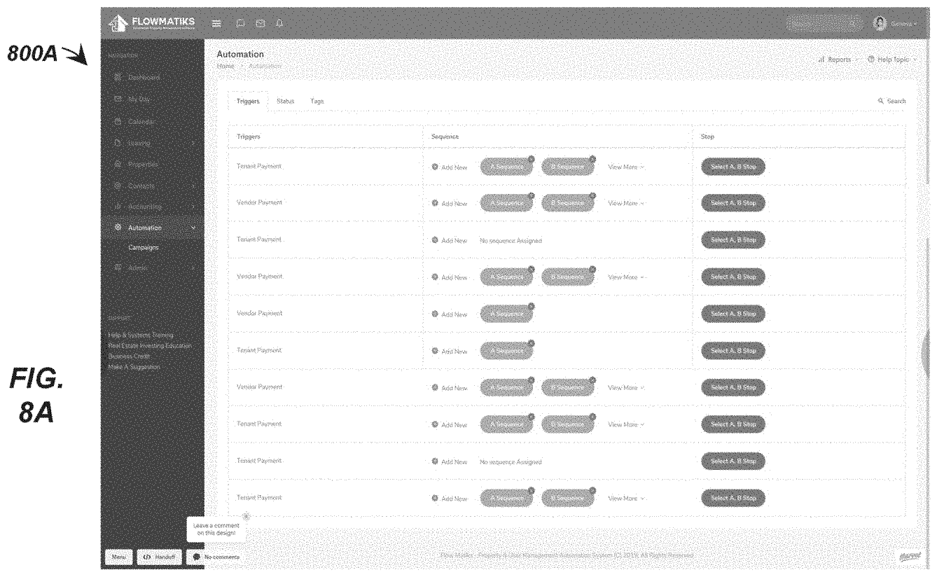

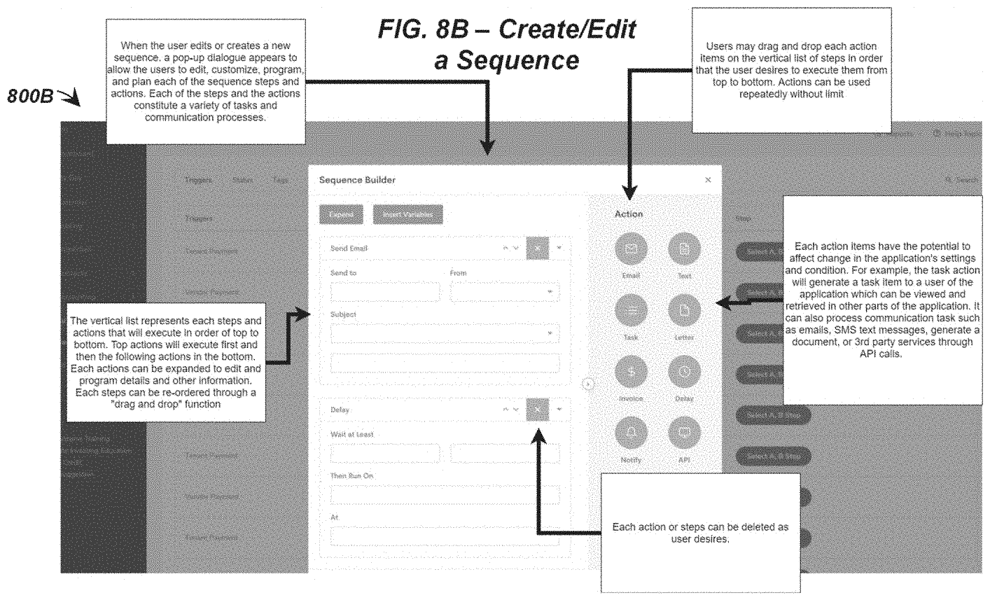

FIGS. 8A and 8B illustrate exemplary user interfaces (GUIs) showing exemplary options for creating and editing a sequence. In some embodiments, the system may provide GUIs 800A and 800B for users to create a new sequence and/or edit an existing one. The system may provide a pop-up dialogue to allow the users to edit. Customize, program and plan each of the sequence steps and actions. Each of the steps and actions may constitute a variety of tasks and communication processes. As shown in FIG. 8A, in some embodiments, a trigger (conditions and situations) may be selectable on the GUI's left side of the main content area. In the middle of the GUI, the user may create a new sequence funnel object for the correlating trigger. On the GUI's right side, the user can designate the condition and situation that would halt the sequence from continuing if such condition or situation is met. FIG. 8B shows an exemplary pop-up GUI with further descriptions for building a sequence.

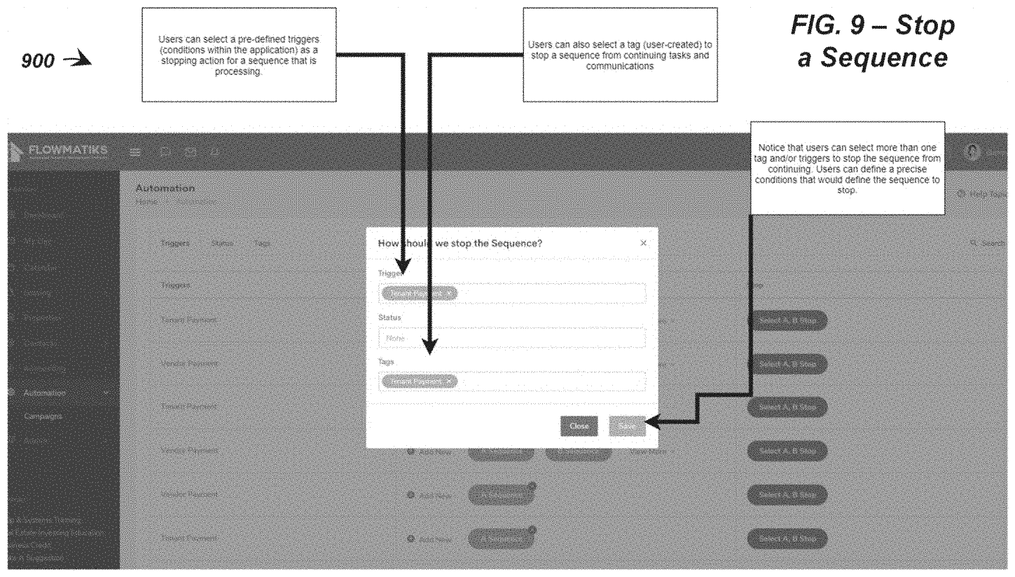

FIG. 9 illustrates an exemplary user interface (GUI) showing exemplary options for stopping a sequence. In some embodiments, users may select one or more tag and/or trigger to stop a sequence from continuing. FIG. 9 shows further detailed descriptions.

In some embodiments, the system of the present disclosure is optimized for faster page loading speed and minimal internet bandwidth requirement to allow a larger pool of users to enjoy the experience of using the application of the present disclosure.

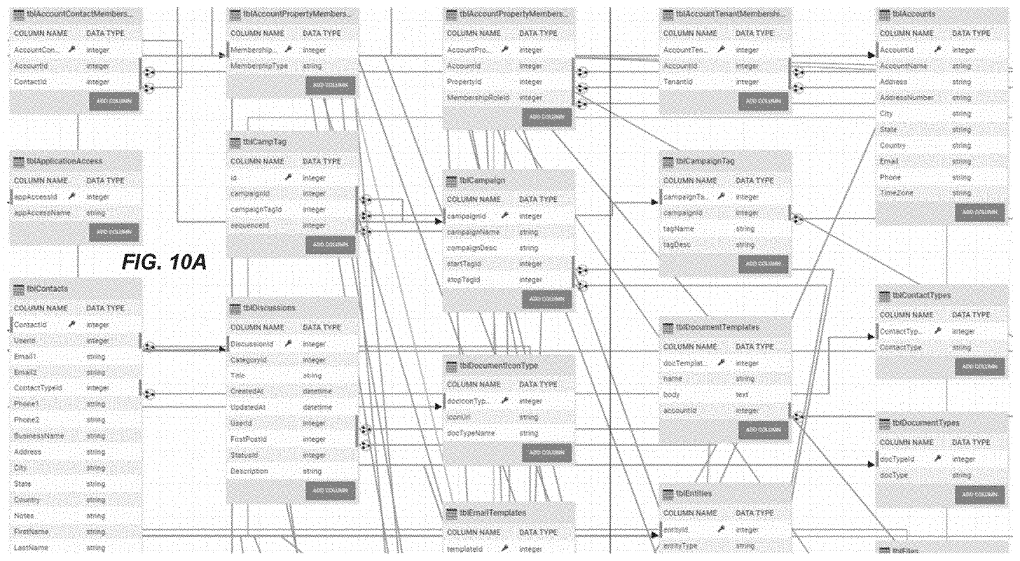

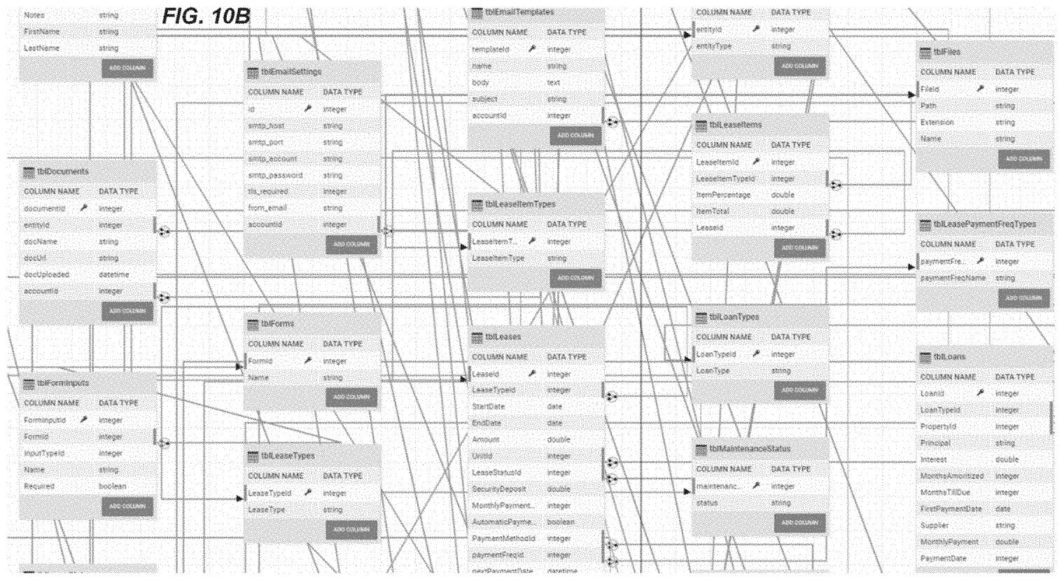

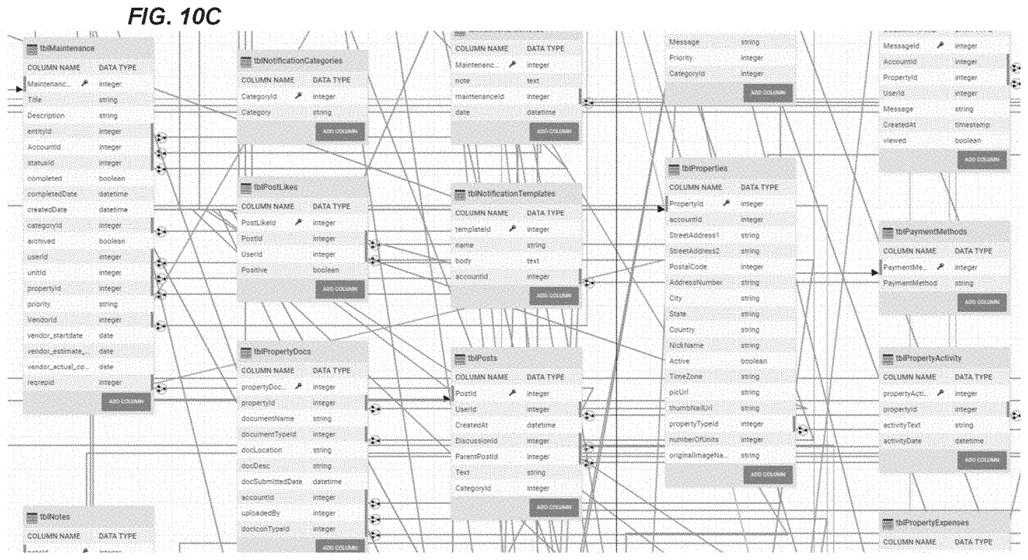

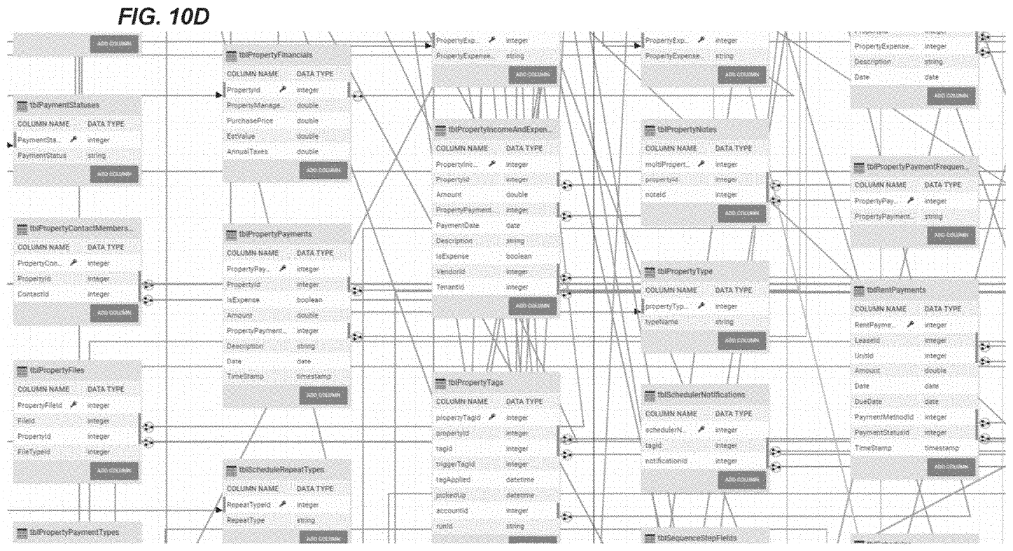

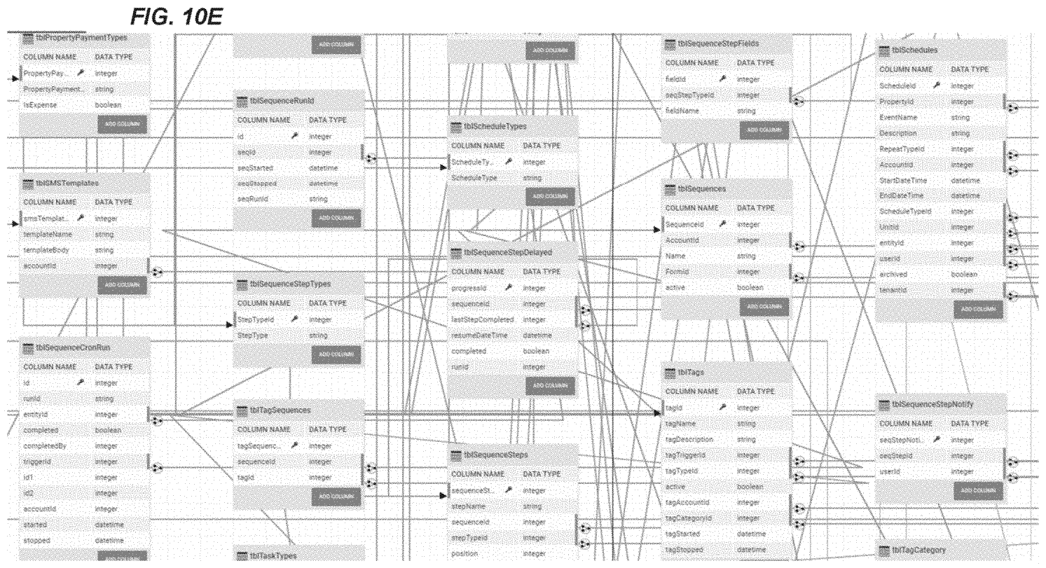

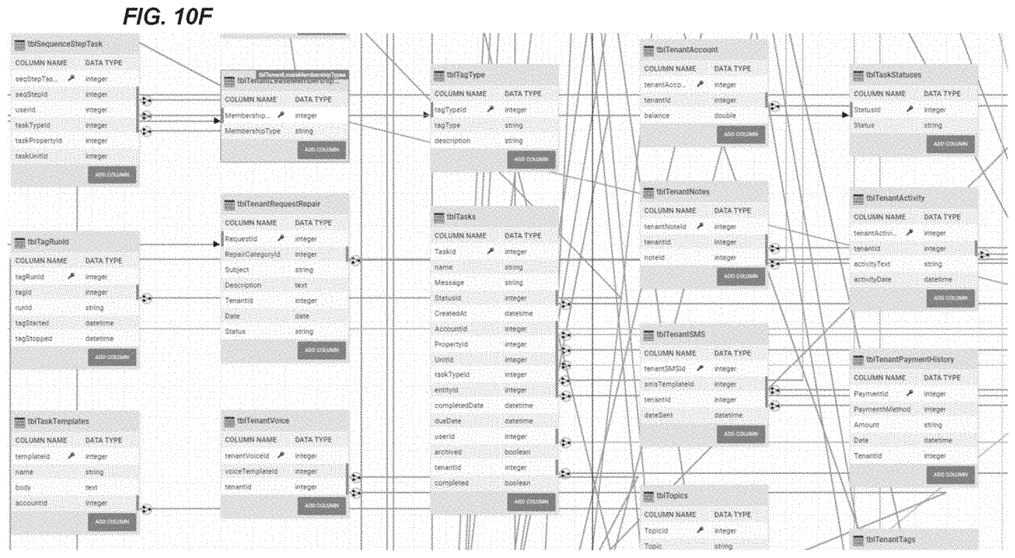

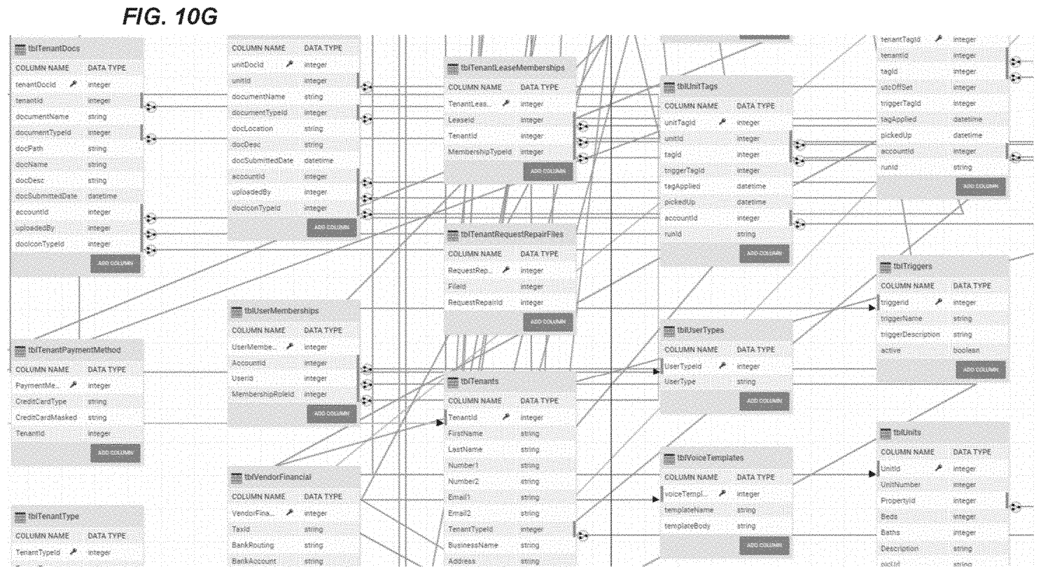

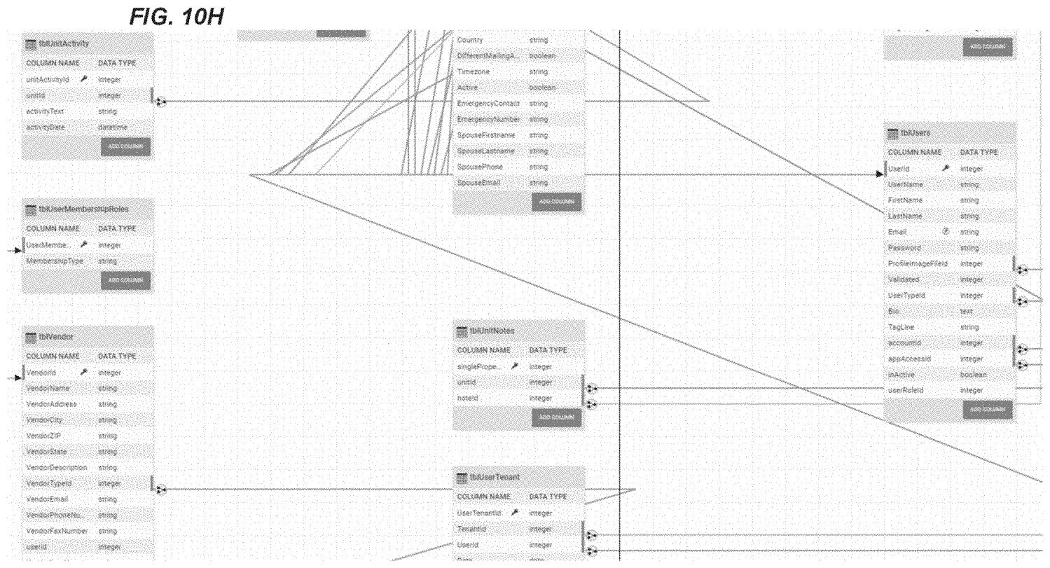

FIGS. 10A to 10H illustrates exemplary data structures used in support of systems, procedures and methods of the present disclosures.

In some exemplary implementations, the database of the system may be hosted on a web service, for example through Amazon Web Service Relational Database Service (RDS) using mySQL. In the exemplary property management operation, the database may collect and store information such as identifiable information of tenants, real estate owners, vendors, and the application user. Such information may include but are not limited to names, age, date of birth, address, tax identification number, such as an Employer Identification Number (EIN), a Taxpayer Identification Number (TIN), or a Social Security Number (SSN), email addresses, phone numbers, and alias of such person. Furthermore, the database may store transactional and activity data of such people and organization such as payment activity (not payment method), income information, monthly payable rent amount/balance, activity while using the application, lease documents, agreements between parties, IP address and web profile of such users.

It should be noted although the above examples relate to property management, the system and methods of the present disclosure may also apply to other fields.

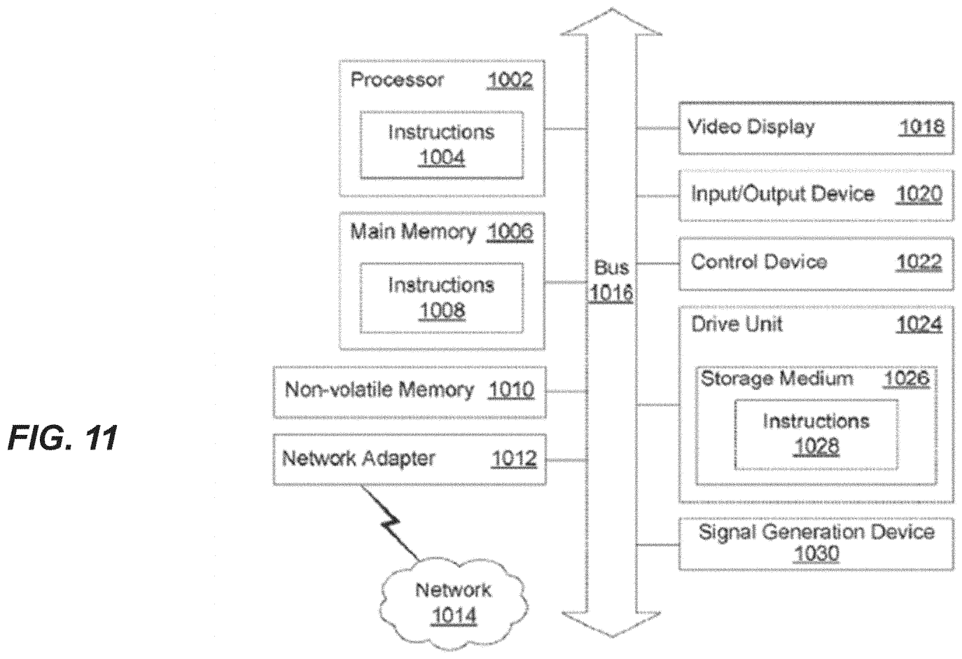

FIG. 11 illustrates an exemplary block diagram illustrating an example of a processing system 1000 in which at least some operations described herein can be implemented. In some embodiments, the processing system may include one or more central processing units (“processors”) 1002, main memory 1006, nonvolatile memory devices 1010, network adapter 1012 (e.g., network interfaces), video display 1018, input/output devices 1020, control device 1022 (e.g., keyboard and pointing devices), drive unit 1024 including a storage medium 1026, and signal generation device 1030 that are communicatively connected to a bus 1016. The bus 1016 is illustrated as an abstraction that represents any one or more separate physical buses, point to point connections, or both connected by appropriate bridges, adapters, or controllers. The bus 1016, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the processing system 1000 operates as a standalone device, although the processing system 1000 may be connected (e.g., wired or wirelessly) to other machines. For example, in some embodiments components of the processing system 1000 are housed within a computer device used by a user to access the server (or server system) 140, while in other embodiments components of the processing system 1000 are housed within a computer-implemented system responsible for supporting the user device application 121. In a networked deployment, the processing system 1000 may operate in the capacity of a server or a client machine in a client-server network environment, or as a peer machine in a peer-to-peer (or distributed) network environment. The processing system 1000 may be a server, a personal computer (PC), a tablet computer, a laptop computer, a personal digital assistant (PDA), a mobile phone, a processor, a web appliance, a network router, switch or bridge, a console, a hand-held console, a (hand-held) gaming device, a music player, any portable, mobile, hand-held, wearable device, or any machine capable of executing a set of instructions (sequential or otherwise) that specify actions to be taken by the processing system.

While the main memory 1006, nonvolatile memory devices 1010, and storage medium 1026 (also called a “machine-readable medium”) are shown to be a single medium, the term “machine-readable medium” and “storage medium” should be taken to include a single medium or multiple media (e.g., a centralized or distributed database, and/or associated caches and servers) that store one or more sets of instructions 1028. The term “machine-readable medium” and “storage medium” shall also be taken to include any medium that is capable of storing, encoding, or carrying a set of instructions, e.g., “code,” for execution by the processing system and that cause the processing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 1004, 1008, 1028) set at various times in various memory and storage devices in a computer, and that, when read and executed by one or more processing units or processors 1002, cause the processing system 1000 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the operations.

Further examples of machine-readable storage media, machine-readable media, or computer-readable (storage) media include, but are not limited to, recordable type media such as volatile and nonvolatile memory devices 1010, removable disks, hard disk drives, optical disks (e.g., Compact Disk Read-Only Memory (CD ROMS), Digital Versatile Disks, (DVDs)), and transmission type media such as digital and analog communication links.

The network adapter 1012 enables the processing system 1000 to mediate data in a network 1014 with an entity that is external to the processing system 1000, through any known and/or convenient communications protocol supported by the processing system 1000 and the external entity. The network adapter 1012 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1012 can include a firewall that can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

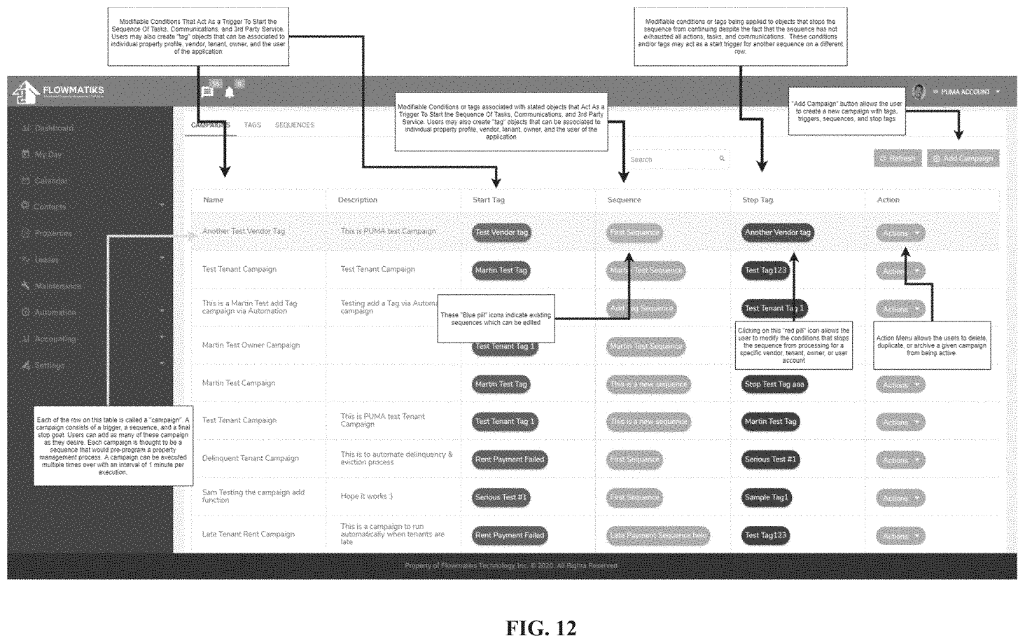

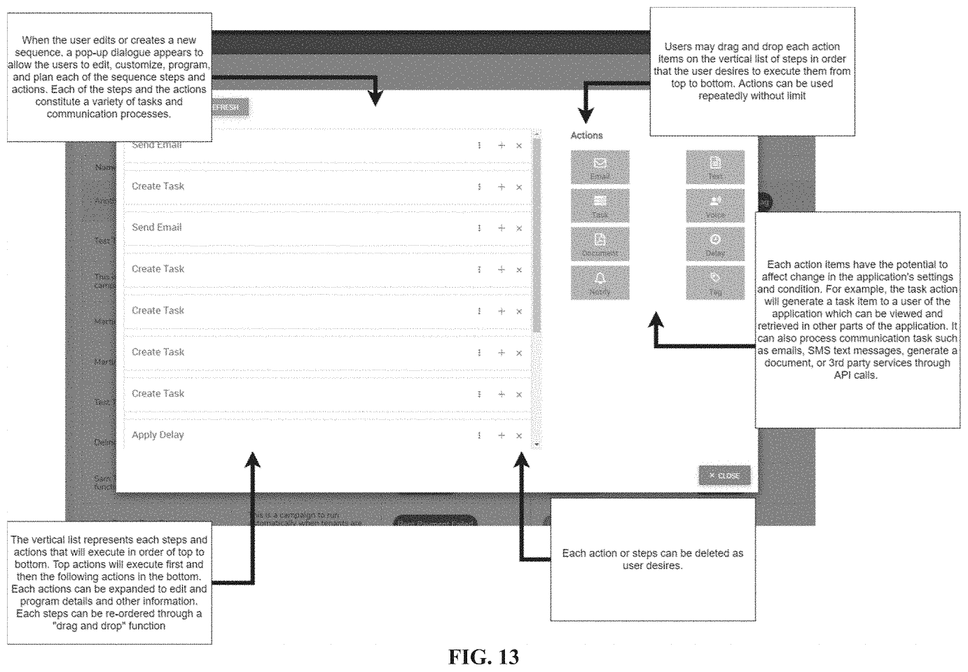

FIGS. 12 and 13 illustrate exemplary user interfaces (GUIs) showing exemplary options for creating and editing a sequence. In some embodiments, the system may provide GUIs 800A and 800B for users to create a new sequence and/or edit an existing one. The system may provide a pop-up dialogue to allow the users to edit. Customize, program and plan each of the sequence steps and actions. Each of the steps and actions may constitute a variety of tasks and communication processes. As shown in FIG. 8A, in some embodiments, a trigger (conditions and situations) may be selectable on the GUI's left side of the main content area. In the middle of the GUI, the user may create a new sequence funnel object for the correlating trigger. On the GUI's right side, the user can designate the condition and situation that would halt the sequence from continuing if such condition or situation is met. FIG. 13 shows an exemplary pop-up GUI with further descriptions for building a sequence.

Referring now to FIG. 12, as illustrated the name and start tag may be modifiable conditions that act as a trigger to start the sequence of tasks communications and third-party service. Users may also create tag objects that can be associated to individual property profiles, e.g., for vendors, tenants, owners and the user of the application. Each of the rows on the table may be called a campaign period. A campaign may comprise a trigger, a sequence, and a final stop goal. Users may add as many of the campaigns as they desire. Each campaign may be thought to be a sequence that may preprogram a property management process. A campaign can be executed multiple times over with an interval of one minute per execution in one example. In other embodiments, other intervals may be used, e.g., 30 seconds, 90 seconds, 1 to 120 seconds, or longer intervals. Icons in the sequence column may indicate sequences that are editable.

In an example embodiment, modifiable conditions or tags associated with state objects that may act as a trigger to start a sequence of tasks, communications, and third-party services may be referred to as sequences. The users may also create tag objects that can be associated to individual property profiles, vendors, tenants, owners, and the user of the application.

In an example embodiment, a stop tag may be a modifiable condition or tag being applied to objects that stop the sequence from continuing even though the sequence has not exhausted all actions, tasks, and communications. These conditions and/or tags may act as a start trigger for another sequence on a different row.

The ad campaign button may allow a user to create a new campaign with tags, triggers, sequences, and stop tags. The action menu may allow the user to delete, duplicate, or archive a given campaign from being active

Referring now to FIG. 13, in the illustrated example, when the user edits or creates a new sequence, a popup dialog box may appear to allow the user to edit, customize, program, and plan each of the sequence steps and actions. Each of the steps, actions, may constitute a variety of tasks and communication processes. Users may drag and drop each action item on the vertical list of steps in order that the user desires to execute them from top to bottom. Actions may generally be used repeatedly, e.g., without limit. In the illustrated example of FIG. 13, the vertical list may represent each step and action that will execute in order from top to bottom. Actions at the top of the list may execute first and then actions lower on the list all the way to the bottom of the list. In an example embodiment, each of the actions may be expanded to edit and program details and other information. In an example embodiment, each step may be reordered through a drag and drop function. In an example embodiment, each action or step may be deleted by a user.

In the illustrated example of FIG. 13, each action item may have the potential to affect changes in the applications settings and conditions. For example, the task action may generate a task item to a user of the application which may be viewed retrieved in other parts of the application. An action item may also process communication tasks such as emails, SMS texts messages, generated documents, or third-party services through API calls.

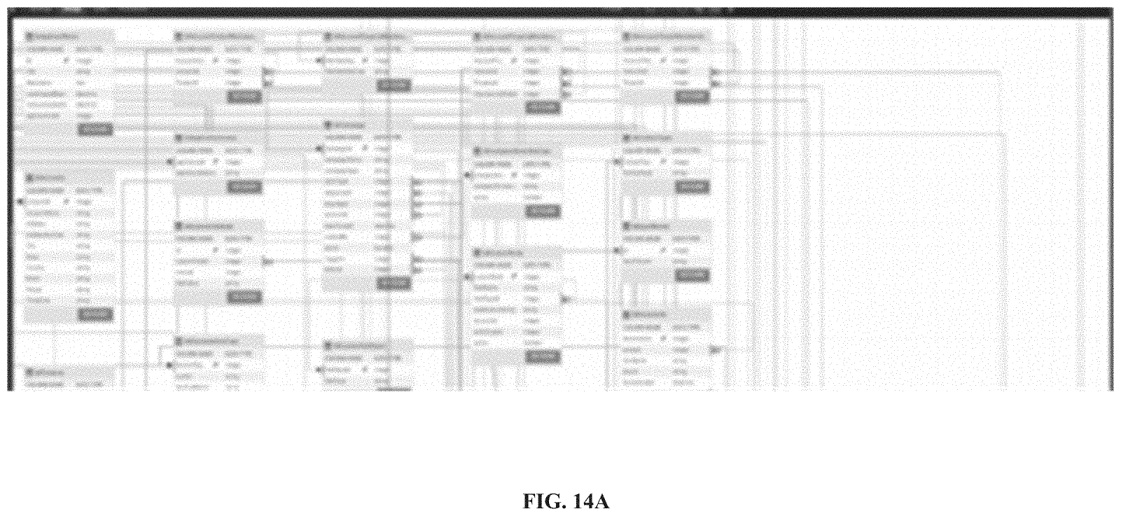

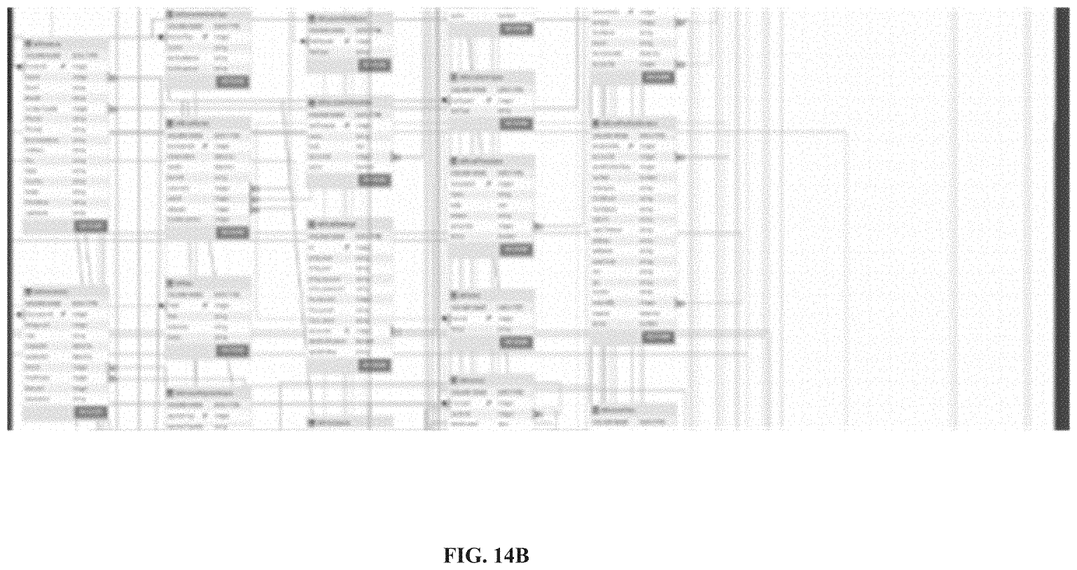

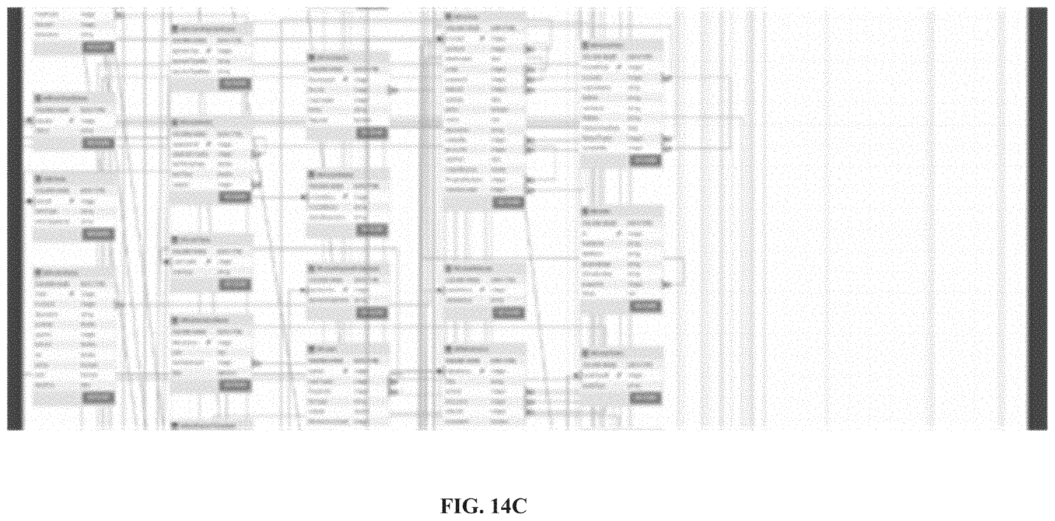

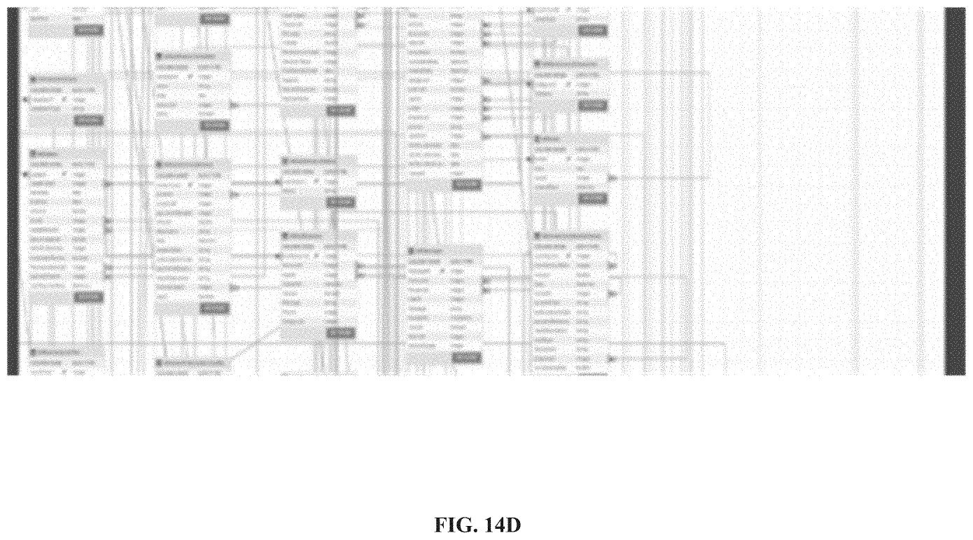

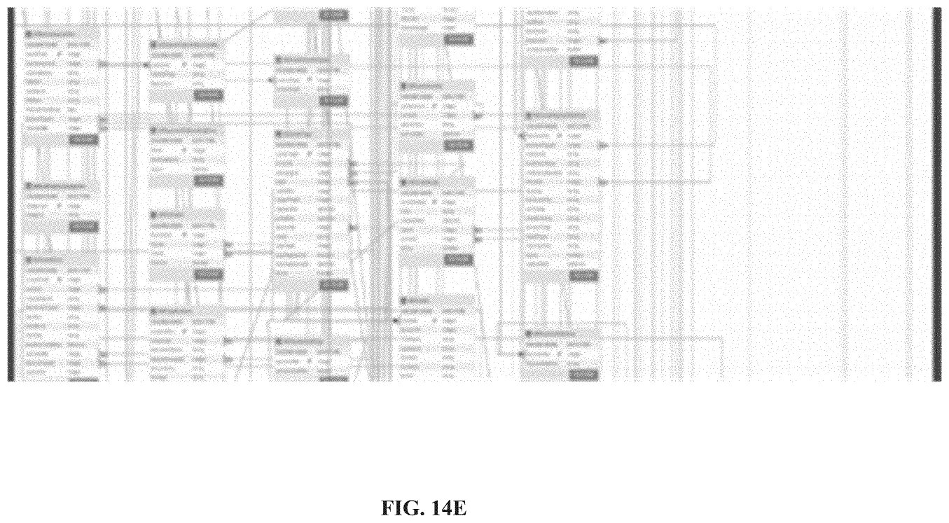

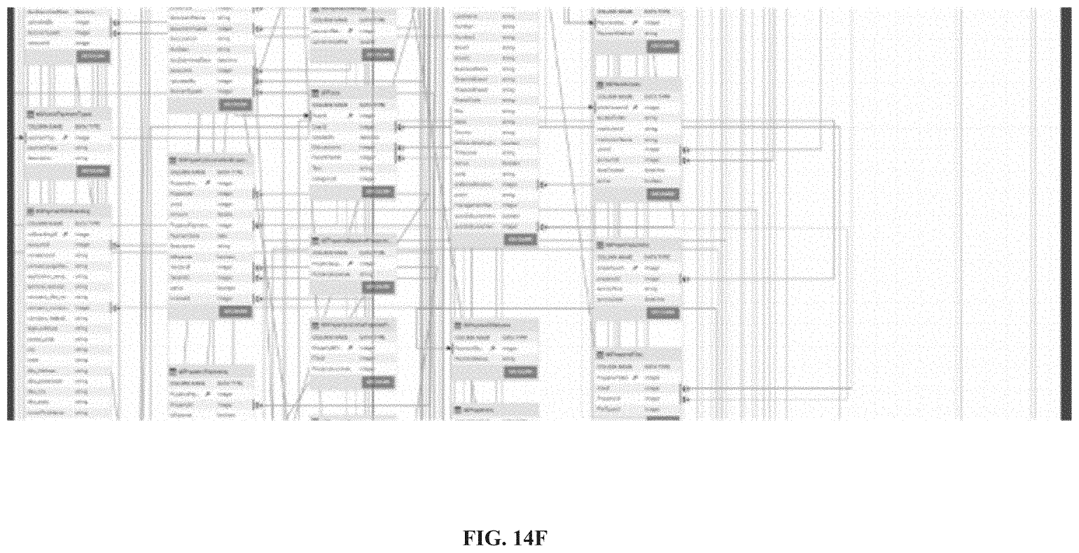

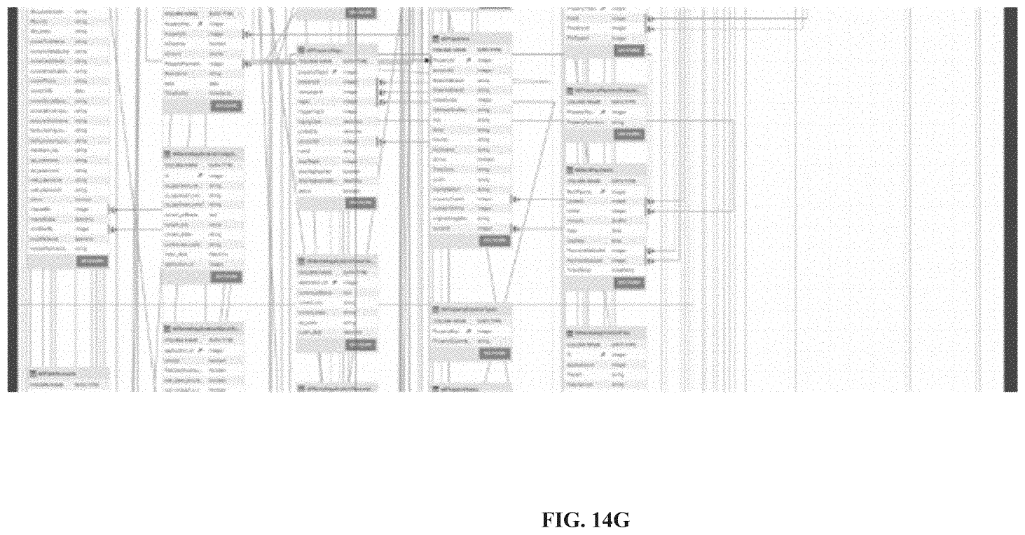

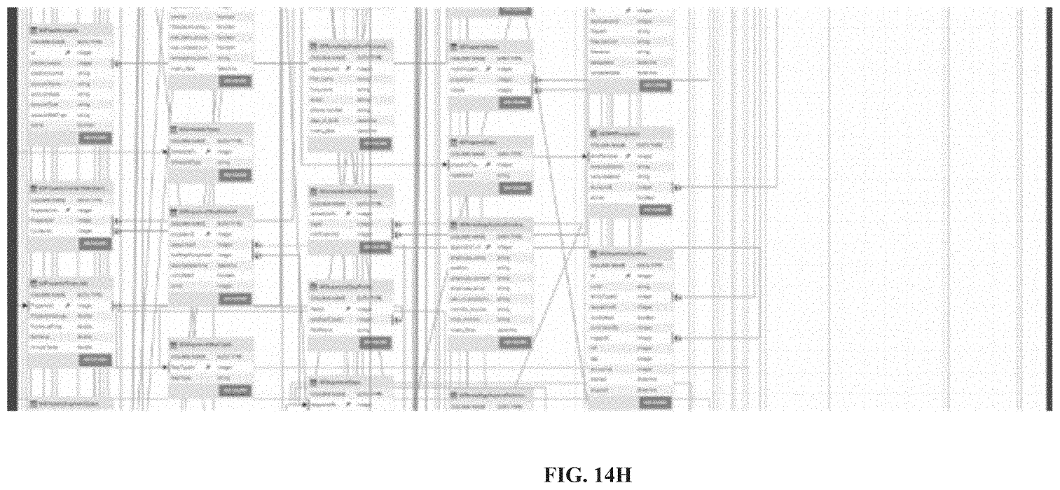

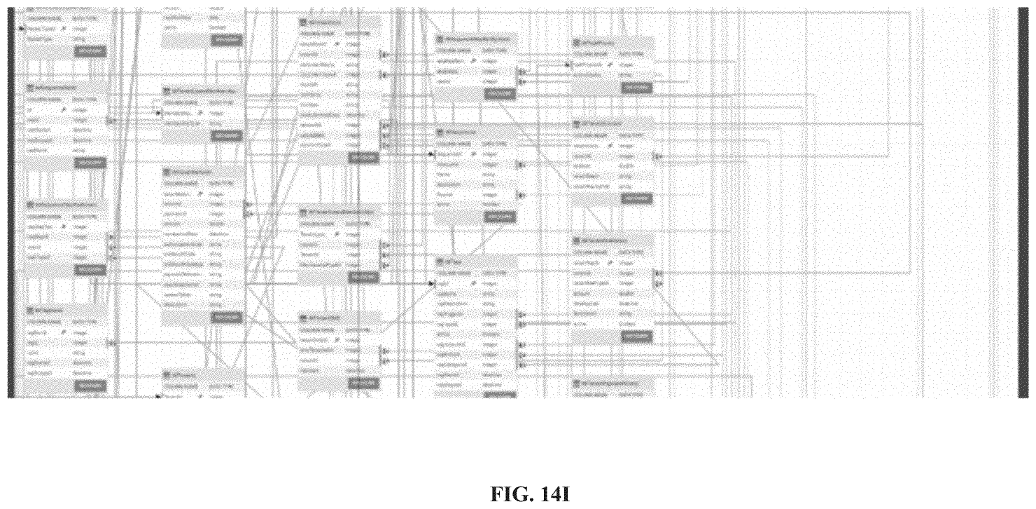

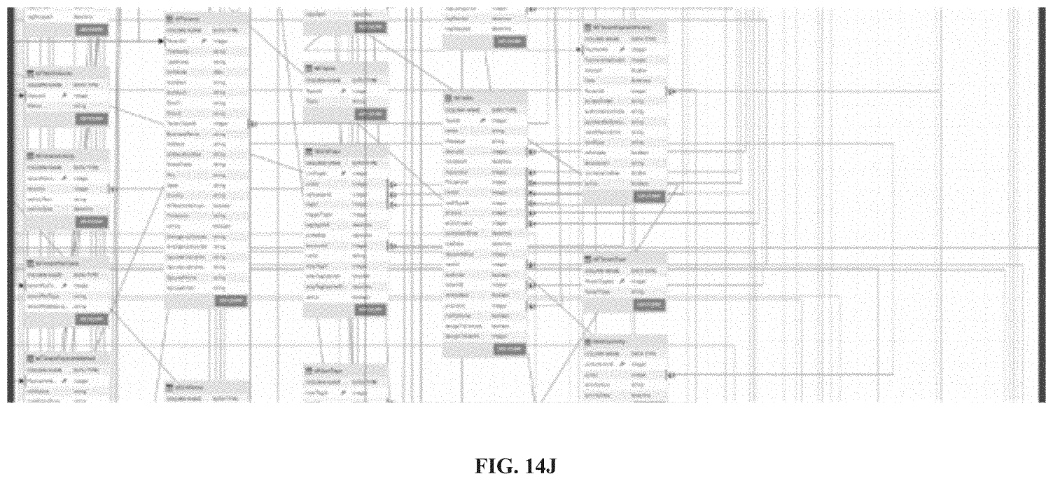

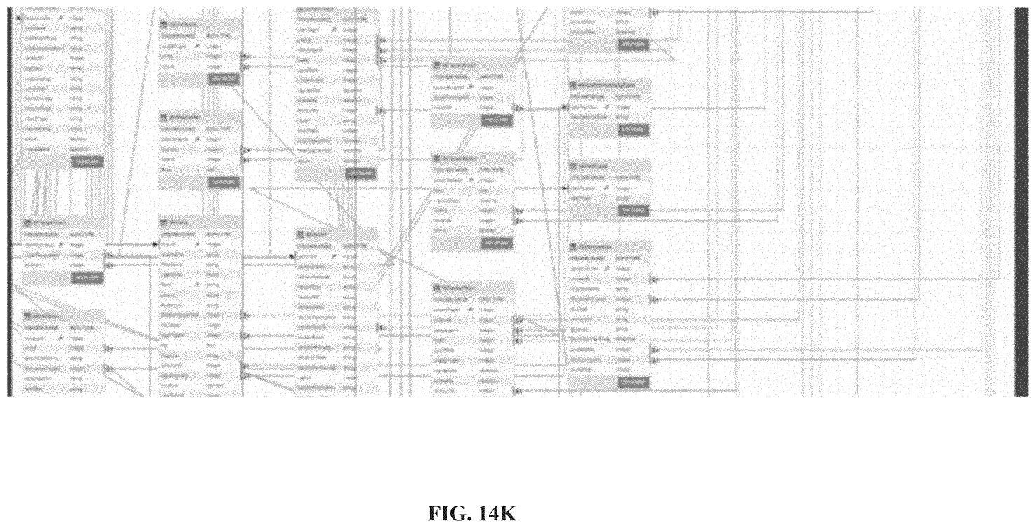

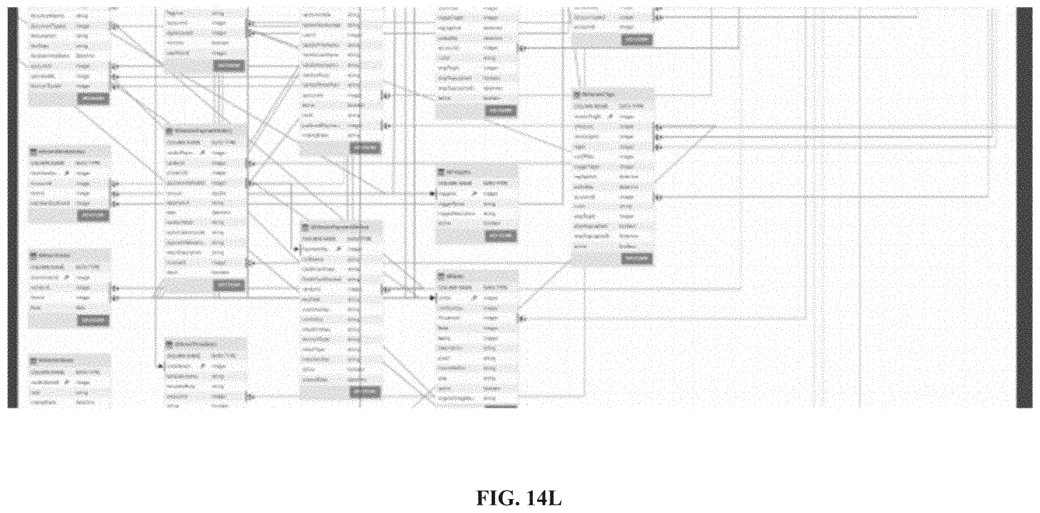

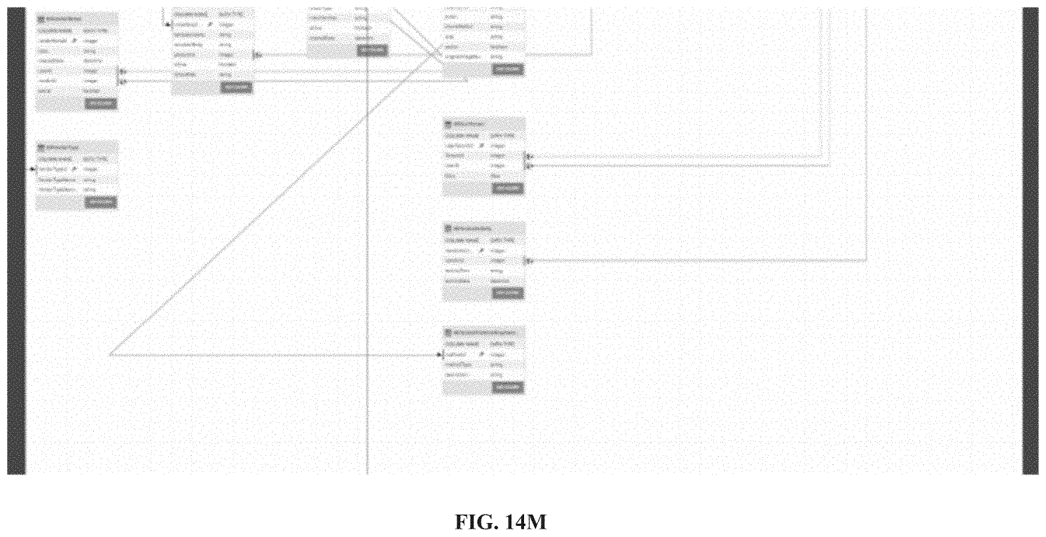

FIGS. 14A to 14M illustrate other exemplary data structures used in support of systems, procedures and methods of the present disclosures.

In some exemplary implementations, the database of the system may be hosted on a web service, for example through Amazon Web Service Relational Database Service (RDS) using mySQL. In the exemplary property management operation, the database may collect and store information such as identifiable information of tenants, real estate owners, vendors, and the application user. Such information may include but are not limited to names, age, date of birth, address, tax identification number, such as an Employer Identification Number (EIN), a Taxpayer Identification Number (TIN), or a Social Security Number (SSN), email addresses, phone numbers, and alias of such person. Furthermore, the database may store transactional and activity data of such people and organization such as payment activity (not payment method), income information, monthly payable rent amount/balance, activity while using the application, lease documents, agreements between parties, IP address and web profile of such users.

It should be noted although the above examples relate to property management, the system and methods of the present disclosure may also apply to other fields.

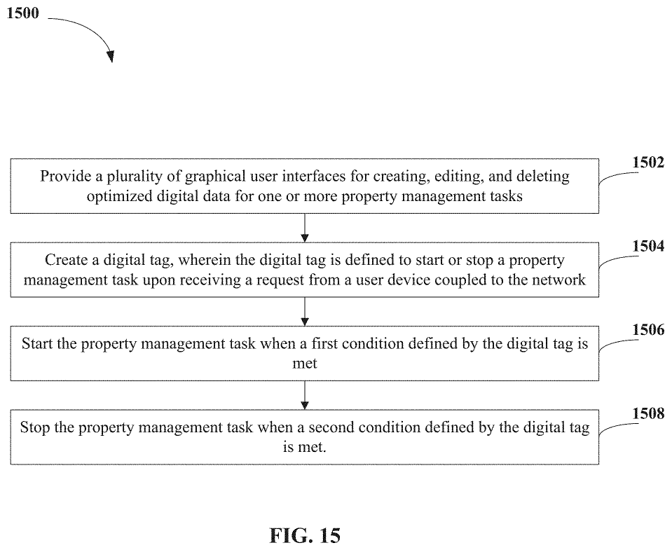

FIG. 15 is a flowchart of an example method 1500. The method 1500 may be a method for a computer system coupled to a network for scheduling and optimizing property management communications, activities, and tasks. In an example embodiment, the method 1500 may include providing a plurality of graphical user interfaces for creating, editing, and deleting optimized digital data for one or more property management tasks (1502). The method 1500 may include creating a digital tag, wherein the digital tag is defined to start or stop a property management task upon receiving a request from a user device coupled to the network (1504). The method 1500 may include starting the property management task when a first condition defined by the digital tag is met (1506). The method 1500 may include stopping the property management task when a second condition defined by the digital tag is met (1508).

Providing a plurality of graphical user interfaces for creating, editing, and deleting optimized digital data for one or more property management tasks (1502) may include a processor generating a screen image for the plurality of graphical user interfaces for creating, editing, and deleting optimized digital data for one or more property management tasks. Providing the plurality of graphical user interfaces for creating, editing, and deleting optimized digital data for one or more property management tasks (1502) may also include causing the screen images to be displayed on one or more monitors. Additionally, providing a plurality of graphical user interfaces for creating, editing, and deleting optimized digital data for one or more property management tasks (1502) may include receiving inputs from a user through the graphical user interface.

Creating a digital tag, wherein the digital tag is defined to start or stop a property management task upon receiving a request from a user device coupled to the network (1504) may include determining a start for a property task, determining a stop for a property task, generating the digital tag to define the start and/or stop of the property management task upon receiving a request from a user device coupled to the network.

Starting the property management task when a first condition defined by the digital tag is met (1506) may include testing for the first condition defined by the digital tag, determining that the first condition is met, and beginning the property management task based on the determination that the first condition is met.

Stopping the property management task when a second condition defined by the digital tag is met (1508) may include testing for the second condition defined by the digital tag, determining that the second condition is met, and ending the property management task based on the determination that the second condition is met.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer-readable media, then that memory, storage, and/or computer-readable media are non-transitory. Accordingly, to the extent that memory, storage, and/or computer-readable media are covered by one or more claims, then that memory, storage, and/or computer-readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a Compact Disk Read Only Memory (CD-ROM), or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. A non-transitory computer-readable medium may include any non-transitory computer-readable media, such as, but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the figures may be configured to perform one or more of the methods, features, or steps described in the figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A computer system coupled to a network for scheduling and optimizing property management communications, activities, and tasks, the computer system configured to:
provide a plurality of graphical user interfaces for creating, editing, and deleting optimized digital data for one or more property management tasks;
upon receiving a request from a user device coupled to the network, create a digital tag, wherein the digital tag is defined to start or stop a property management task;
start the property management task when a first condition defined by the digital tag is met; and
stop the property management task when a second condition defined by the digital tag is met.

2. The computer system of claim 1, wherein the property management task comprises a sequence.

3. The computer system of claim 2, wherein the computer system is further configured to check for the second condition, the second condition comprising a condition for the sequence to complete.

4. The computer system of claim 3, wherein the second condition comprises the sequence exhausting all schedules of programmable communications, actions, and tasks.

5. The computer system of claim 3, wherein the second condition comprises a condition designated by a user to terminate the sequence.

6. A method for a computer system coupled to a network for scheduling and optimizing property management communications, activities, and tasks, the method comprising:
providing a plurality of graphical user interfaces for creating, editing, and deleting optimized digital data for one or more property management tasks;
creating a digital tag, wherein the digital tag is defined to start or stop a property management task upon receiving a request from a user device coupled to the network;
starting the property management task when a first condition defined by the digital tag is met; and
stopping the property management task when a second condition defined by the digital tag is met.

7. The method of claim 6, wherein the property management task comprises a sequence.

8. The method of claim 7, wherein the computer system is further configured to check for the second condition, the second condition comprising a condition for the sequence to complete.

9. The method of claim 8, wherein the second condition comprises the sequence exhausting all schedules of programmable communications, actions, and tasks.

10. The method of claim 8, wherein the second condition comprises a condition designated by a user to terminate the sequence.

11. A non-transitory computer-readable medium for a computer system coupled to a network for scheduling and optimizing property management communications, activities, and tasks comprising code for:
providing a plurality of graphical user interfaces for creating, editing, and deleting optimized digital data for one or more property management tasks;
creating a digital tag, wherein the digital tag is defined to start or stop a property management task upon receiving a request from a user device coupled to the network;
starting the property management task when a first condition defined by the digital tag is met; and
stopping the property management task when a second condition defined by the digital tag is met.

12. The non-transitory computer-readable medium of claim 11, wherein the property management task comprises a sequence.

13. The non-transitory computer-readable medium of claim 12, wherein the computer system is further configured to check for the second condition, the second condition comprising a condition for the sequence to complete.

14. The non-transitory computer-readable medium of claim 13, wherein the second condition comprises the sequence exhausting all schedules of programmable communications, actions, and tasks.

15. The non-transitory computer-readable medium of claim 13, wherein the second condition comprises a condition designated by a user to terminate the sequence.
